(19) United States
(12) Patent Application Publication
(10) Pub. No.: US 2006/0046305 A1
(43) Pub. Date: Mar. 2, 2006

(54) Method and apparatus for detecting analyte with filter

(75) Inventors: Wen-Tso Liu, Singapore (SG); Simon S. Ang, Fayetteville, AR (US); Linng Zhu, Singapore (SG)

Correspondence Address: KLARQUIST SPARKMAN, LLP, 121 SW SALMON STREET, SUITE 1600, PORTLAND, OR, 97204, US

(73) Assignee: National University of Singapore

(21) Appl. No.: 10/966,840

(22) Filed: Oct. 14, 2004

Related U.S. Application Data
(60) Provisional application No. 60/511,114, filed on Oct. 15, 2003.

(51) Int. Cl. G01N 31/22

(52) U.S. Cl. 436/164

(57) ABSTRACT

To detect an analyte, a fluid is flown through a filter. The fluid carries signal producing members smaller in size than the analyte and having affinity to specifically attach to the analyte. The filter is adapted for trapping the analyte while allowing passage of unattached ones of the signal producing members. A signal produced by one or more of the signal producing members can be sensed upstream of the filter to detect the analyte trapped by the filter.

### CROSS-REFERENCE TO RELATED APPLICATION

This application claims priority from U.S. provisional application No. 60/511,114, entitled “Integrated Filter-based MEMS Device for Parallel Concentrating and Detection of Microbial Cells” and filed Oct. 15, 2003, which is incorporated herein by reference.

### FIELD OF THE INVENTION

The present invention relates generally to sample analysis, and more particularly to method and apparatus for detection of analytes.

### BACKGROUND OF THE INVENTION

Rapid and accurate detection of microbial cells in fluids can save life. For example, it is estimated that infectious diseases cause nearly 20 million deaths a year, a majority of which are transmitted through physical contact with contaminated water. Early detection of infectious micro-organisms in water sources can thus significantly reduce risks of outbreaks of certain infectious diseases, or biological terror attacks. Detection of microbial cells in fluids also has various other applications, such as clinical assaying and air quality control or monitoring.

There are known techniques for detecting micro-organisms in water samples or human specimens. As the potential content of the target cells in a sample solution is usually not high enough to permit detection, the sample solution is typically concentrated before analysis. The concentrated sample is analyzed by various assaying techniques to detect the presence or the amount of the target microbial cells. Example techniques for assaying immunological cells include immunofluorescence (IF) and enzyme-linked immunosorbent assay, flow cytometry sorting, polymerase chain reaction or restriction enzyme digestion, immuno-magnetic separation, and the like. Description of some of these techniques can be found in Walter Quintero-Betancourt et al., “Cryptosporidium parvum and Cyclospora cayetanensis: a review of laboratory methods for detection of these waterborne parasites,” Journal of Microbiological Methods, (2002), vol. 49, pp. 209-224; and Giles H. W. Sanders et al., “Chip-based Microsystems for genomic and proteomic analysis,” Trends in Analytical Chemistry, (2000), vol. 19, pp. 364-378, each of which is incorporated herein by reference.

Recently, microfluidic devices or micro electromechanical systems (MEMS) have been employed to detect biological molecules, proteins, and cells. See for example, Ann E. Grow et al., “New biochip technology for label-free detection of pathogens and their toxins,” Journal of Microbiological Methods, (2003), vol. 53, pp. 221-233; Chuanmin Ruan et al., “Immunobiosensor chips for detection of Escherichia coli O157:H7 using electrochemical impedance spectroscopy,” Analytical Chemistry, (2002), vol. 74, pp. 4814-4820 [“Ruan”]; Ying Huang et al. “Dielectrophoretic cell separation and gene expression profiling on microelectronic chip arrays,” Analytical Chemistry, (2002), vol. 74, pp. 3362-3371 [“Huang”]; Ronald Pethig et al., “Dielectrophoretic studies of the activation of human T lymphocytes using a newly developed cell profiling system,” Electrophoresis, (2002), vol. 23, pp. 2057-2063 [“Pethig”]; Michael P. Hughes, “Strategies for dieclectrophoretic separation in laboratory-on-a-chip systems,” Electrophoresis, (2002), vol. 23, pp. 2569-2582 [“Hughes”]; Jing Cheng et al., “Fluorescent imaging of cells and nucleic acids in bioelectronic chips,” Proceedings of SPIE-The International Society for Optical Engineering 1999, 3600, pp. 23-28; Lin Luo et al., “Gene expression profiles of laser-captured adjacent neuronal subtypes,” Nature Medicine, (1999), vol. 5, no. 1, pp. 117-121; Vasile I. Furdui and D. J. Harrison, “Immunomagnetic Separation of Rare Cells on Chip for DNA Assay Sample Preparation”, in Micro-Total Analysis Systems 2001, Proceedings of the μTAS 2001 Symposium, 5th, held in Monterey, Calif., United States, Oct. 21-25, 2001, (2001), pp. 289-290 [“Furdui”]; Vasile I. Furdui and D. J. Harrison, “The influence of flow channel geometry on capture efficiency of rare cells using protein A-anti human CD3 magnetic beads,” in Micro Total Analysis Systems 2002, Proceedings of the μTAS 2002 Symposium, 6th, held in Nara, Japan, Nov. 3-7, 2002, (2003), vol. 2, pp. 700-702; and Kiichi Sato et al., “Integration of an immunosorbent assay system: analysis of secretory human immunoglobulin A on polystyrene beads in a microchip,” Analytical Chemistry, (2000), vol. 72, pp. 1144-1147 [“Sato”]; each of which is incorporated herein by reference. These techniques generally involve two steps, a capture step and an identification step. Various different cell capture techniques have been used. The sample solution is typically fed through microstructured fluid channels. The channel surface can be coated with proteins or antibodies that specifically bind to the target cells so as to capture the target cells when they flow by the proteins or antibodies. An alternative capture technique is dielectrophoresis (DEP), wherein the movement of particles are confined in a non-uniform alternative-current (AC) electric field and then captured by laser micro-dissection (see e.g. Huang, Pethig, and Hughes). A further alternative capture technique is to use magnetic beads (see e.g. Furdui).

However, the aforementioned techniques each suffer some drawbacks. Many of them involve additional steps of chemical preparation (see for example Ruan and Sato). The time required for testing a sample is relatively long, usually lasting from two to three hours to a couple of days. Some techniques, such as cytometry and some of the MEMS based techniques, require sophisticated and expensive equipment and skilled human operators. In some cases, tests can only be carried out in laboratories and are not suitable for on-site or online monitoring and detection. Some of these techniques require the attachment of the cells to a surface before detection and may have limited application in cases where the cells do not readily attach to the surface or where attachment of the cells to the surface is not desirable. When the detection device has a coated channel surface for capturing a specific type of cells, it may not be suitable for detecting other types of cells, nor can it be used to detect multiple types of cells simultaneously.

Sato discloses a technique in which polystyrene beads are introduced into a microchannel on a microchip and are retained by a dam in the microchannel. Antigens are adsorbed on the surfaces of the beads. Antibodies conjugated with colloidal gold are fixed on the bead surfaces by antigen-antibody binding. Free antigens are washed out and colloidal gold bound to the bead surfaces via the antigen-antibody complex are then detected with a thermal lens microscope. This technique avoids some of the drawbacks discussed above. However, this technique still has some drawbacks. First, pre-concentration of the sample may still be required as this technique may not work well when the antibody solution has a very low concentration: some antibodies can pass through the microchannel without being bound to the antigen. Secondly, as discussed above, some antibodies may not have antigens that can be adsorbed on the bead surface or it may not be desirable to fix the antigens or the antibodies to a surface. Thirdly, the antibody-colloidal gold conjugate has to be prepared in advance of introducing it into the microchannel.

Thus, there is a need for an improved method and apparatus for rapid detection of analytes. There is also a need for an apparatus suitable for detection of different types of analytes, either separately or simultaneously.

### SUMMARY OF THE INVENTION

An analyte can be detected using a filter that traps the analyte but allows passage of signal producing members that can specifically attach to the analyte. To detect the analyte, a fluid carrying the signal producing members is flown through the filter. If the analyte is trapped at the filter, some signal producing members can attach to the analyte and be trapped as well. If no analyte is trapped, the signal producing members will pass through the filter. Thus, a signal produced by the trapped signal producing members at the filter can indicate the presence or amount of analyte trapped by the filter. The analyte may be trapped at the filter by, for example, passing a sample potentially containing the analyte through the filter.

Advantageously, it is not necessary to pre-concentrate the sample as the analyte can concentrate at the filter when the sample is passed through the filter. Since no or little analyte in the sample will be lost and the analyte can accumulate at the filter, the analyte concentration in the sample does not need to be high. The detection can be performed in less time than many conventional techniques. Further, since more than one signal producing members may attach to the analyte, signal strength and hence detection sensitivity can be high. It is also less expensive to prepare a carrying fluid that has a low concentration of signal producing members, which is sufficient as the carrying fluid can be flown by the trapped analyte for any desired period of time. Re-use of the carrying fluid is also possible. Moreover, with a single filter more than one type of analytes may be detected either separately or simultaneously.

Thus, in an aspect of the invention there is provided a method of detecting an analyte, comprising flowing a fluid through a filter, the fluid carrying signal producing members smaller in size than the analyte and having affinity to specifically attach to the analyte, the filter adapted for trapping the analyte while allowing passage of unattached ones of the signal producing members; and sensing a signal produced by one or more of the signal producing members upstream of the filter so as to detect the analyte trapped by the filter.

In another aspect of the invention there is provided a device for detecting an analyte, comprising a body having walls defining a fluid path; a filter for trapping the analyte in the fluid path but allowing passage of signal producing members smaller in size than the analyte and having affinity to specifically attach to the analyte; the analyte trapped in the path by the filter; and at least one of the walls allowing transmission of a signal produced by the signal producing members attached to the analyte such that the analyte can be detected by sensing the signal.

In further aspect of the invention, there is provided a device for detecting an analyte, comprising a wall having a first portion and a second portion, the first and second portions defining a fluid path, the path having a closed, downstream end and an open, upstream end, the path narrowing from the upstream end towards the downstream end, each of the first and second portions having a plurality of openings disposed along the path to allow a fluid to pass through the wall, the openings being sufficiently small for preventing passage of an analyte carried by the fluid, wherein the fluid tends to force the analyte in the path towards the downstream end to leave at least some of the openings unblocked by the analyte; an inlet in fluid communication with the path for feeding the fluid and the analyte into the upstream end of the path; an outlet in fluid communication with the openings for allowing the fluid to exit the path.

In another aspect of the invention, there is provided a device for detecting an analyte, comprising: a body having walls defining a fluid path; a filter for trapping the analyte in the fluid path but allowing passage of signal producing members smaller in size than the analyte and having affinity to specifically attach to the analyte; a screen disposed upstream of the filter in the fluid path for blocking objects larger than the analyte; and at least one of the walls allowing transmission of a signal produced by the signal producing members attached to the analyte such that the analyte can be detected by sensing the signal.

Other aspects, features, and benefits of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate exemplary embodiments of the invention,

FIG. 1 schematically illustrates a method of detecting an analyte with a filter;

FIG. 2A is a partial front sectional view of a device having a weir-type filter;

FIG.2B is a partial side sectional view of the device of FIG. 2A along the line B-B;

FIG. 3 is a partial side sectional view of a device having a pillar-type filter;

FIG. 4A is a schematic view of a device having pillar-type filters;

FIG. 4B is an enlarged view of a filter on the device of FIG. 4A encircled in circle B;

FIG. 4C illustrates the filter of FIG. 4B in operation;

FIG. 4D is an enlarged view of the coarse screens on the device of FIG. 4A encircled in circle D;

FIG. 5 is a schematic diagram illustrating a device having twelve pillar-type filters;

FIGS. 6A-6C are experimental images showing trapped analytes in the device of FIG. 2A;

FIG. 7 is a simulated flow rate profile for the device of FIG. 2A;

FIG. 8 is a diagram showing the detected signal strength along the height of the weir of the device of FIG. 2A;

FIG. 9 is a diagram showing the dependence of detected signal strength on the flow rate of the labelling solution; and

FIG. 10 is a diagram showing the dependence of detected signal strength on the concentration of the labelling solution.

### DETAILED DESCRIPTION

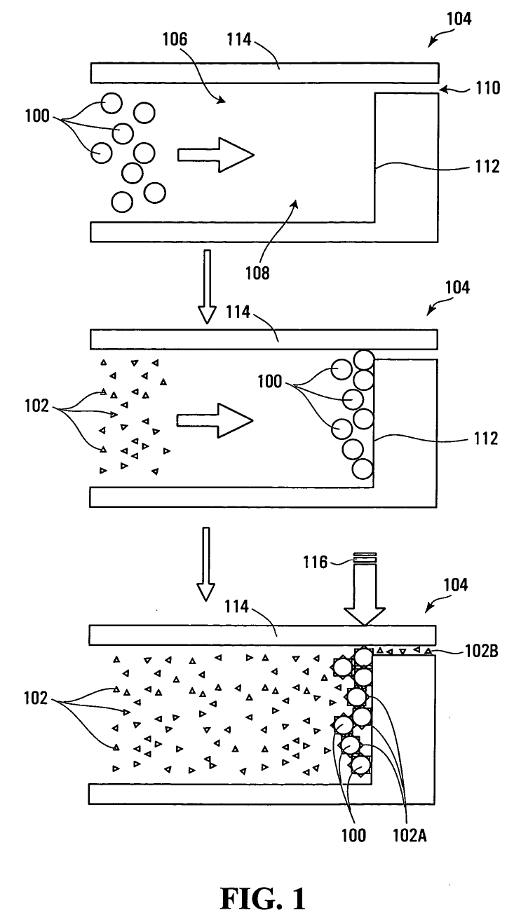

FIG. 1 illustrates a method of detecting an analyte 100, exemplary of embodiments of the invention.

Analyte 100 is the target subject matter of an analysis or detection. It is usually contained in a sample, such as a sample solution. Analyte 100 can be one or more large objects that have specific affinity with a certain type of small objects. The large objects have a certain physical size but can be rigid or deformable. For example, analyte 100 can be one or more biological molecules, microbial cells, or other cells. Analyte 100 can be, or have on its surface, a target molecule, which can specifically capture or be specifically captured by a capture molecule. For example, the pair of target and capture molecules can be a pair of antigen and antibody, a pair of ligand and receptor, a pair of biotin and avidin (including streptavidin), a pair of substrate and enzyme, a pair of sense and antisense oligonucleotides, or the like. The pair of capture and target molecules have specific affinity with each other. That is, each of the capture and target molecules can recognize and bind to the other. The pair can bind to each other by conjugation, linkage, chemical bond, or the like. The binding can be covalent or non-covalent. The term “specific” or “specifically” refers to the selectivity of a capturing object, i.e., the capturing object only captures selected or specific groups of other objects, of which the target object is one but not necessarily the only one. Although higher specificity can improve the accuracy of the detection outcome, the degree of specificity may vary depending on the type of analyte and the application. However, the specificity should not be too low, as will become apparent from the description below. While analyte 100 can be deformable, only those objects that can maintain a minimum physical size are suitable objects of analyte 100, as will become clear from the description below.

The method makes use of signal producing members 102, which have affinity to specifically attach to analyte 100 and are smaller in size than analyte 100. For clarity, signal producing members attached to analyte 100 are referred to as 102A and unattached signal producing members are referred to as 102B. Collectively and individually, signal producing members are referred to as 102 when it is not necessary to distinguish between attached and unattached ones.

Signal producing members 102 can produce detectable signals, either naturally or spontaneously, or under stimulation or when activated by a change in its environment. For example, signal producing members may produce a radioactive, fluorescent, chemiluminescent, colorimetric, electric, magnetic, electromagnetic, or other suitable signal. When analyte 100 includes a target molecule, each signal producing member may include a capture molecule that can specifically capture or be specifically captured by the target molecule. For example, labelled probes such as antibodies, proteins and nucleic acids used in conventional cell detections, biomolecule or protein analysis, or similar analysis can be used. Signal producing members may be labelled with any suitable labels known to persons skilled in the art, including radioactive labels, fluorescent labels, chemiluminescent labels, colorimetric labels, quantum dots (QD), gold nanoparticle labels, and the like. Example techniques of labelling and cell/protein analysis can be found in the references cited above, and in J. F. Leary, “Strategies for rare cell detection and isolation”, Methods In Cell Biology, (1994), vol. 42, pp. 331-358; G. Vesey et al, “Evaluation of fluorochromes and excitation sources for immunofluorescence in water samples,” Cytometry, (1997), vol. 29, pp. 147-154; and Liang Zhu et al., “Quantum dots as a novel immunofluorescent detection system for Cryptosporidium parvum and Giardia lamblia,” Applied and Environmental Microbiology, (2004), vol. 70, pp. 597-598, each of which is incorporated herein by reference. For example, when the analyte includes microbial cells such as Cryptosporidium parvum and Giardia lamblia, QD antibody bioconjugates can be used as signal producing members. The target cells may be bound with biotinylated antibodies before conjugating QDs to the cell-attached antibodies. The QDs may be coated with streptavidin. Alternatively, the QDs may be linked to antibodies and then be attached to the target cells.

Example labels include enzymes and substrates, chromogens, catalysts, fluorescent material; chemiluminescent material, radioactive material, colloidal metallic particles such as gold, colloidal non-metallic particles such as selenium, dyed or colored particles such as dyed plastic or stained micro-organism, colored or colourable organic polymer latex particles, liposomes or other vesicles containing directly visible substances, and the like. A mixture of the labels may also be used.

Signal producing members 102 may include both a label and a binding component when the label is not itself selectively attachable to analyte 100. The binding component can be the capture molecule or any other object that has specific affinity to attach to analyte 100. Example binding component includes antigen, antibody, hapten, substrate, enzyme, enzyme cofactors, enzyme inhibitors, biotin, avidin, carbohydrates, lectins, proteins, protein binders, nucleic acids such as DNAs, nucleotide sequences, peptide sequences, peptide binders, effector and receptor molecules, polymeric acids, polymeric bases, and the like. If an antibody is used, it can be monoclonal, polyclonal, recombinant, or chimeric. A mixture of these binding components can be used. Functional fragments of any of the above substances can also be used. It is also possible that the binding component only temporarily bind to analyte 100 and is detached from analyte 100 after the label has been attached to analyte 100. In such a case, the binding component acts as a label carrier to specifically deliver the label to analyte 100.

The method also makes use of a filter 104 for trapping analyte 102 but allowing passage of unattached signal producing members 102B.

Filter 104 defines a fluid flow path or conduit 106. Path 106 has a wide section 108 and a narrow section 110, which are contiguous. As depicted, the sections are joined adjacent a wall 112. Sections 108 and 110 are respectively sized so that analyte 100 can move within section 108 but cannot move from section 108 into section 110. Further, sections 108 and 110 are shaped and sized so that trapped analyte 100 will not block flow path 106 and unattached signal producing members 102B can pass from section 108 into section 110. As can be understood, Filter 104 may have any suitable construction for trapping analyte 100 while allowing unattached signal producing members 102B to pass through, as will be further illustrated below.

Filter 104 is also constructed to allow sensing of a signal produced by attached signal producing members 102A. For example, one of the walls surrounding or defining path 106, such as the top wall 114, may be transparent so that a fluorescent or colorimetric signal can be sensed by a sensor 116. Similarly, when the signal to be sensed is radioactive, electric, magnetic or electromagnetic, at least one of the walls should have a window or be made of a material that allows the signal to pass through or otherwise be transmitted therethrough.

To detect analyte 100 in a sample (not shown), such as a sample solution, in which analyte 100 may or may not be present and may be present in different amounts, the sample is introduced into section 108. For illustration purposes, in the following description with reference to FIG. 1 it is assumed that the sample does contain analyte 100. For clarity, only analyte 100 is shown in FIG. 1.

As illustrated at the top of FIG. 1, analyte 100 in section 108 are moved towards section 110, as indicated by the arrow. Such movement can be effected in any number of manners know to persons skilled in the art. For example, analyte 100 can be carried by a fluid flow. The fluid flow can either carry or not carry signal producing members 102.

As illustrated in the middle of FIG. 1, a fluid (not shown) carrying signal producing members 102 is flown through filter 104 in the direction indicated by the arrow. The concentration of signal producing members 102 in the carrying fluid can vary and can be relatively low, for example as compared to the concentrations of labelled probes in conventional cell analysis. The fluid flow conveniently pushes analyte 100 towards section 110 and against wall 112. The fluid flow rate may be constant or fluctuate depending on the particular application. The fluid can be a liquid or a gas.

As illustrated at the bottom of FIG. 1, while unattached signal producing members 102B can pass through filter 104, attached signal producing members 102A are trapped with analyte 100 to which they attach. The fluid flow may be maintained for a period of time to ensure that sufficient or maximum numbers of signal producing members 102A are attached to analyte 100. However, in some applications, it may be sufficient that only one signal producing member attaches to analyte 100.

Generally, the flow rate of the carrying fluid can be maintained within a range selected to achieve good performance. For example, the flow rate should be high enough to attach sufficient signal producing members 102A to the trapped analyte 100 within a desired period of time, and, if required, to maintain analyte 100 in its trapped position. However, a very high flow rate may not be desirable. For example, increasing the flow rate above a certain limit may not result in improved detection efficiency but wasted resources. Further, a very high flow rate may not be desirable when analyte 100 is deformable, because it may cause pressure build-up and deform analyte 100 extensively, even forcing analyte 100 through filer 104.

A suitable sensing technique with the use of a sensor, such as sensor 116, is then employed to sense a signal produced by attached signal producing members 102A, which are trapped together with analyte 100 by filter 104. Sensor 116 can be any suitable sensor for detecting the particular type of signal. For example, for detecting florescent signals an epifluorescence microscope may be used; for detecting colorimetric signals, a magnifying glass may be used. A signal stimulating or activation source may also be used if the signal is not naturally or spontaneously produced but requires stimulation or activation. Lights or radiations may be directed from a source to the filter region. The light or radiation source may be separated from or incorporated into the sensor. To excite QDs, a stationary or portable ultraviolet (UV) source such as a portable UV lamp may be used.

To accurately sense the signal from signal producing members 102A, it may be advantageous to reduce or calibrate the background signal. Background signal includes background noises and signals produced by unattached signal producing members 102B that may be present in section 108 and close to wall 112, for example, those signal producing members 102 that are in the fluid flow but not yet attached or passed through filter 104. To eliminate or reduce background signal, a blank fluid, which does not carry any signal producing members 102, may be flown through filter 104 after flowing the carrying fluid for a suitable period of time so as to flush out unattached signal producing members 102B. It may be advantageous to use a low concentration carrying fluid because the background signal is limited even without flushing. To calibrate for background signal, the background signal may be maintained at a relatively constant level. For example, the carrying fluid flow may be maintained at a relatively constant flow rate so that the concentration of unattached signal producing members 102B in section 108 is at equilibrium and the background signal can be calibrated. The strength of the sensed signal can indicate the presence and the amount of analyte 100 trapped by filter 104. To determine the amount of analyte 100, it may be necessary to monitor the signal until it reaches a maximum. With certain types of analyte, it may be advantageous to use signal producing members that only produce a detectable signal after they are attached to the analyte. It may also be advantageous to use signal producing members that produce distinguishable signals depending on whether they are attached or unattached.

As can be understood, to reduce detection time, one can increase either the flow rate or the concentration of signal producing members 102 in the carrying fluid. However, as discussed above and further below, either or both of the flow rate and the concentration may be limited by other considerations.

Filter 104 may include more than one path and may have one or multiple openings for filtering. As can be understood, additional openings and pathways can increase the overall flow throughput. Further, when there are multiple openings or pathways, the filter can still function when one of the openings or pathways is clogged, e.g., blocked by a large object in the sample.

Multiple filters in parallel arrangement may also be used, for example to increase the overall detectable signal strength.

As can be understood and appreciated by persons skilled in the art, the method described above can be advantageous in certain applications. For example, a high concentration sample or a large volume of the sample is not always necessary, because the filtering can automatically concentrate the analyte. All or almost all of the analyte in the sample will be trapped. Thus, pre-concentration may not be necessary. The detection sensitivity can be high comparing to conventional techniques. Using this method, it is possible to detect a single cell.

Further, the carrying fluid or labelling solution can have a relatively low concentration of signal producing members. As the fluid can continuously flow through the filter, the signal producing members can gradually accumulate on the trapped analyte. It is also possible to recycle the carrying fluid. Low concentration labelling solutions are less costly to prepare. Further, it is not necessary to flush or wash the device before a measurement can be made, as is often required when high concentration labelling solutions are used due to strong background signal.

In addition, the detection can be performed in a relatively short period of time as compared to conventional cell analysis techniques. For example, using the above method it is possible to detect microbial cells within a few minutes, as compared to hours or days, which are common in conventional cell analysis.

According to this method, a single filter can be used for detecting different analytes, either separately or simultaneously, because the carrying fluid can carry different types of signal producing members that specifically attach to different analytes. For instance, when QDs are used as the signal producing objects, it is possible to detect multiple analytes (e.g. 5-6 or more) at a time based on the colors emitted from the QD labels. Further, a QD coated with multiple streptavidin molecules can accept multiple biotinylated antibodies and can thus be selectively attached to different cells.

The equipment or apparatus required for performing the method can be simple, compact, and easy to use, as will be further described below. It can be suitable for online or on-site analysis. The detection can also be automated.

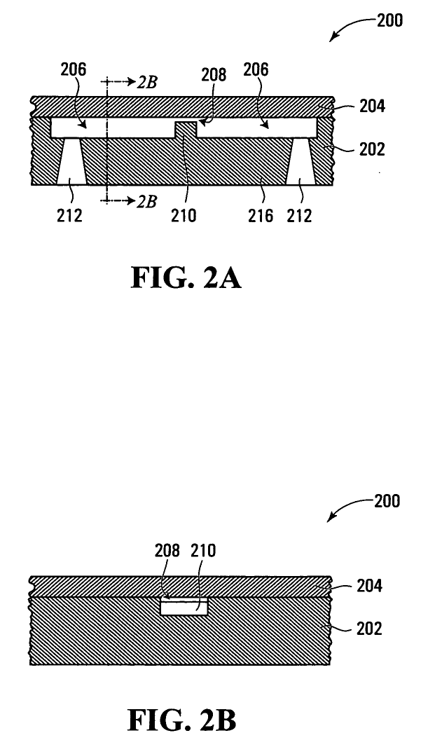

Filter 104 may have various embodiments. FIGS. 2A and 2B illustrate a weir-type filter 200, an exemplary embodiment of filter 104. Filter 200 has a base plate 202 and a transparent cover 204, which has a fluid conduit with three contiguous sections in fluid communication, two deep sections 206 sandwiching a shallow section 208, which is formed above a dam 210, forming what is known in the art as a weir. Base plate 202 also has two ports 212, each in fluid communication with one of the sections 206, for flowing a fluid through filter 200 and for injecting a sample solution into a section 206. Sections 206 and 208 ports 212 may have any suitable shapes or sizes. As depicted, sections 206 and 208 are generally rectangular and ports 212 are generally frusto-conical. In an exemplary embodiment of filter 200 suitable for detecting certain microbial cells, sections 206 and 208 have a width of about 1 mm (the width is measured in the horizontal direction in FIG. 2B); sections 206 have a depth of about 50 μm, and section 208 have a depth between about 1 to 4 μm (the depth is measured in the vertical direction in FIG. 2B); the ports 212 have a minimum diameter of about 1 mm; both base plate 202 and cover 204 are about 20 mm by 20 mm in size; base plate 202 is about 400 μm thick and cover 204 is about 500 μm thick. As can be understood, depending on the application, the above measurements can vary.

As can be understood in comparison with FIG. 1, filter 200 is suitable for practicing the detection method described above. In particular, one of deep sections 206 can provide the wide section of the filter and the shallow section 210 provides the narrow section of the filter.

As depicted, filter 200 is symmetric but in alternative embodiments the fluid conduit and the ports can be asymmetric. For example, dam 210 may be tapered so that section narrows from one side to the other, such as from left to right as depicted. In this configuration, the same filter may be used to detect two analytes that have different sizes. Further, the input and output ports can have different sizes. For example, the input port can be larger than the outlet port. A benefit of having a large sample inlet is that it allows direct insertion of an injection needle into the fluid chamber or conduit so as to reduce sample adhesion to the walls of the inlet.

Filter 200 can be provided on a microfluidic device used for detecting microbial cells, such as a microchip. One device may incorporate one or more filters 200 in parallel. If multiple filters 200 are incorporated, they may share the same input and output ports and sections 206 may be widened in regions proximate the input/output ports, for example to receive a larger volume of fluid or sample.

Base plate 202 may be made of silicon or another material such as glass, ceramics, semiconductor materials, plastics, composites (e.g. polydimethylsiloxane), or the like, or any combination of these materials. Cover 204 may be made of glass. For example, Pyrex™ glass sold by Dow Corning Corporation may be used.

In a particular embodiment, base plate 202 has two cavities and channels connecting the cavities on one of its surfaces, so that when assembled base plate 202 and cover 204 define fluid conduit sections 206 and 208.

Filter 200 and the device incorporating it may be manufactured using conventional manufacturing techniques for semiconductor chips and fluidic devices or MEMS devices, including those techniques described in Peter Van Zant, Microchip Fabrication: A Practical Guide to Semiconductor Processing, 4th ed., McGraull-Hill, New York, N.Y., 2000; Peter Wilding et al. “Integrated cell isolation and polymerase chain reaction analysis using silicon microfilter chambers,” Analytical Biochemistry, (1998), vol. 257, pp. 95-100 [“Wilding”]; and Peter Wilding et al., “Manipulation and flow of biological fluids in straight channels micromachined in silicon,” Clinical Chemistry, (1994), vol. 40, pp. 43-47, each of which is incorporated herein by reference. For example, the channels and cavities on base plate can be fabricated by deep reactive ion etching. The inlet/outlet ports may be fabricated by anisotropic Si etching from the side of the base plate opposite the channels. A nitride layer may be applied to the channel side to protect the etched channels during etching the ports.

Base plate 202 and cover 204 are anionically bonded together. They may also be assembled in any suitable manner known to one of skill in the art.

In operation, filter 200 can be used as filter 104 in the manner described above with reference to FIG. 1. For example, a sample may be introduced into a section 206 through one of the ports 212. A microsyringe may be used for injecting sample solution into port 212 so as to prevent loss of sample solution and the analyte. A fluid carrying signal producing members can then be fed through the same port 212 and exit from the other port 212. A pump may be used to maintain the fluid flow. The flow may be maintained at a constant flow rate, for example, by an automatic syringe pump. Depending on the type of signal producing members, a suitable energy source can be used to stimulate or excite the signal producing members attached and trapped in front of the weir 210 so that they will produce a signal. The signal can be detected using a suitable sensor to determine the presence or amount of any analyte contained in the sample. Filter 200 may be packaged into a microchip holder to facilitate injection and delivery of samples to sections 206.

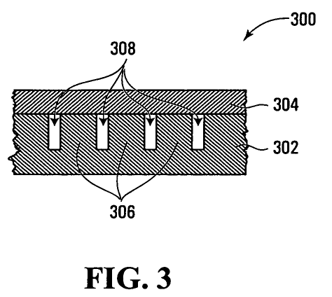

FIG. 3 illustrates a pillar-type filter 300. Filter 300 has base and cover plates 302 and 304 similar to that of filter 200, which define a fluid conduit connecting two input and output ports (not shown). However, instead of weirs, pillars 306 are provided in the conduit for blocking and trapping analyte 100. The gaps 308 between pillars 306 are sufficiently small so that analyte 100 cannot pass through, but are large enough to allow signal producing members 102 to pass through. Pillars 306 may be generally rectangular but they may have other suitable shapes.

In general, filter 104 should be constructed to reduce the possibility of clogging the fluid path by the analyte or other large objects in the sample. In this regard, filters such as weirs or pillars may be arranged in a suitable configuration and pre-filter coarse screens may be used, as further illustrated below.

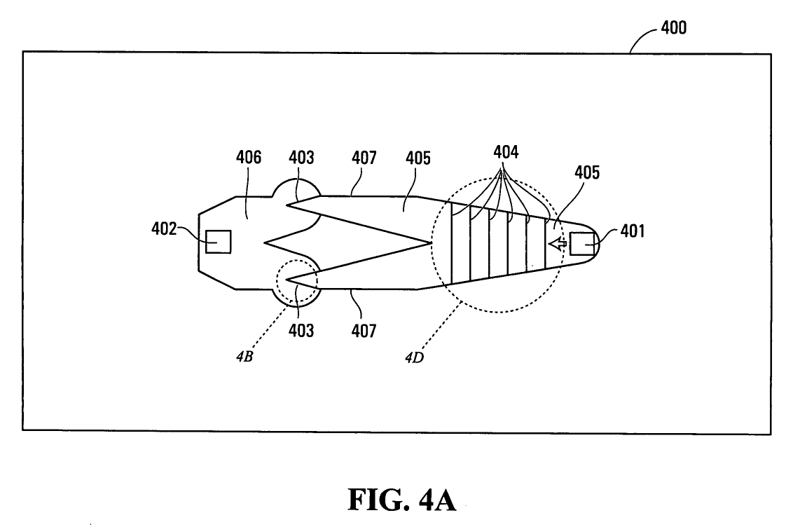

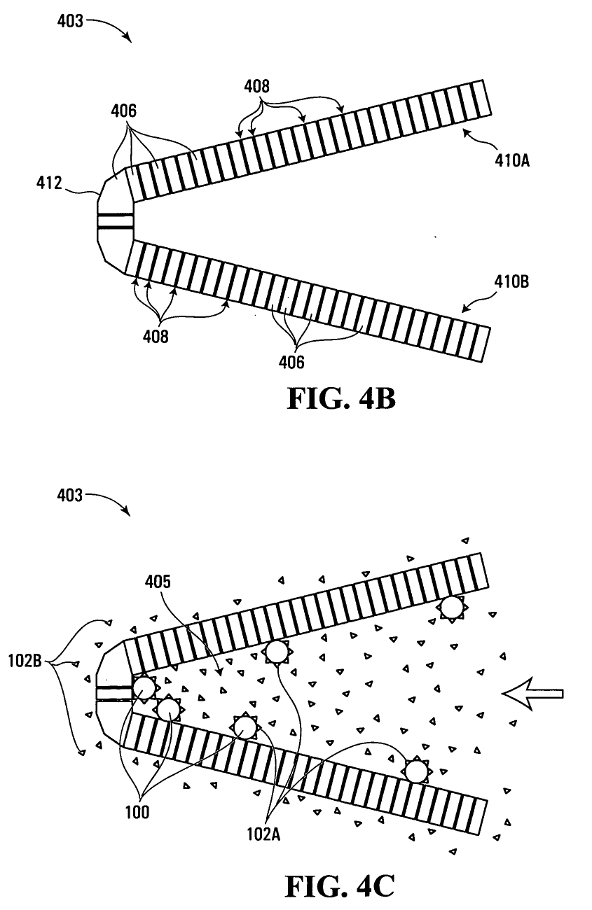

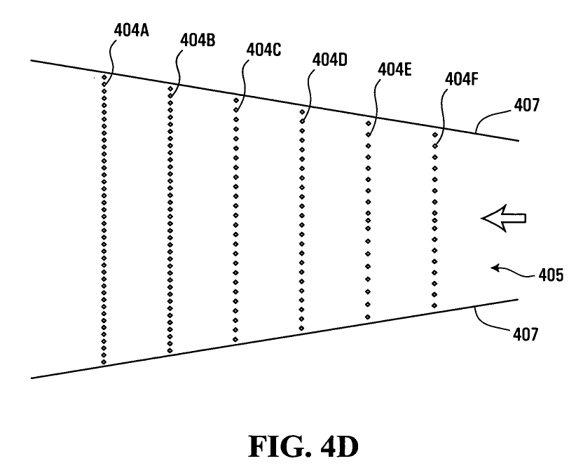

FIG. 4A shows a microfluidic device 400 incorporating pillar-type filters and pre-filter coarse screens. As depicted, device 400 has an inlet 401, outlet 402, pillar-type filters 403, coarse screens 404, and walls 407 defining a fluid conduit connecting input port 401 and output port 402. The conduit has two sections separated by filters 403, section 405 between input port 401 and filters 403; section 406 between filters 403 and output port 402. Thus, a fluid can flow from input 401 to output 402, through coarse screens 404 and then filters 403. Device 400 may be formed from a base plate and a cover plate in similar manner as for forming a device incorporating filter 200 described above.

As better seen in FIG. 4B, which is an enlarged view of a filter 403, a number of pillars 406, which are similar to pillars 306, are arranged in two rows 410A and 410B. Rows 410A and 410B are joined at end 412 but spaced apart at the other, open end. The benefits of this arrangement will become clear below. As in filter 300, gaps or openings 408 are formed between pillars 406 to allow unattached signal producing members to pass. In other words, each filter 403 includes a generally V-shaped wall having a first portion 410A and a second portion 410B. Portions 410A and 410B defines a fluid path between them which has a substantially closed, downstream end and an open, upstream end. The path narrows from the upstream end towards the downstream end. Each of wall portions 410A and 410B has a plurality of openings 408 disposed along the path to allow a fluid and unattached signal producing members 102B to pass through the wall. The openings 408 are sufficiently small for preventing passage of analyte 100. Inlet 401 is in fluid communication with the path for feeding a fluid or analyte 100 into the upstream end of the path. Outlet 402 is in fluid communication with openings 408 for allowing the fluid to exit the path.

FIG. 4C illustrates a filter 403 in operation. As can be seen, analyte 100 can move from the open, upstream end of the path towards the substantially closed, downstream end of the path, but cannot pass through openings 408 so they are trapped within section 405. That is, analyte 100 can move within section 405 but cannot move from section 405 into section 406. When a fluid flow is maintained, the fluid flow can carry analyte 100 towards end 412 as indicated by the arrow. Due to the narrowing path, the fluid tends to force trapped analyte 100 towards the downstream end. Analyte 100 tends to stay and accumulate at the substantially closed, downstream end, thus leaving at least some of openings 408 unblocked by analyte 100. Therefore, trapped analyte 100, or other large objects, will less likely block fluid flow and unattached signal producing members 102B from entering section 406.

As can be understood, filter 403 may have other suitable constructions for trapping analyte 100 while allowing unattached signal producing members 102B to pass through. For example, the wall formed by portions 410A and 410B can be generally U-shaped. The openings 408 can be formed by weirs instead of pillars.

Coarse screens 404 also prevent clogging, by screening out large objects in the sample or the fluid flow. As can be better seen in FIG. 4D, coarse screens 404A to 404F have different mesh sizes to allow different sizes of particles or objects to pass through. Coarse screens 404 are arranged so that their mesh sizes gradually decrease as the sample or fluid flow progresses therethrough to gradually screen out increasingly smaller particles. In other words, each upstream screen has a mesh size larger than the mesh size of the next, downstream screen. As depicted, screen 404A has the smallest mesh sizes and screen 404F has the largest mesh sizes. Each coarse screen 404 has mesh sizes large enough to allow analyte 100 to pass through. For example, the mesh sizes of coarse screens may vary between 50 to 100 μm for detecting microbial cells. The mesh sizes may also have different ranges for different applications. With coarse screens 404 in place, it is possible to detect samples that contain large objects without pre-treatment of the sample. Thus, detection and analysis can be quickly performed.

In alternative embodiments, each coarse screen can have a zigzag overall shape so that large objects stopped in front of the screen will not completely block the fluid flow.

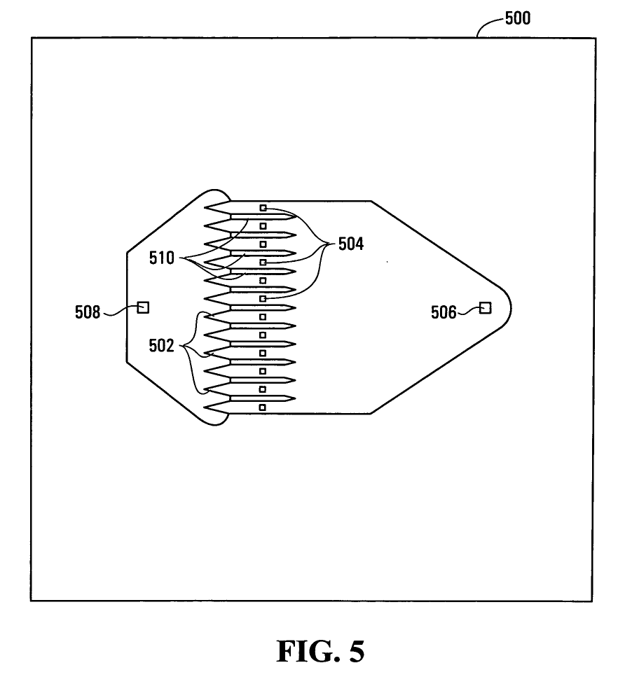

Referring to FIG. 5, a single microfluidic device, such as device 500, may have a plurality of filter channels, such as pillar-type filter channels 502. On device 500, twelve pillar-type filter channels 502 are arranged in parallel. In different embodiments, there may be more or less filter channels. Each filter channel 502 has a filter construction similar to that of filter 403. As depicted, each filter channel 502 is operatively connected to a corresponding sample inlet 504 and all channels 502 share the same fluid inlet 506 and fluid outlet 508. Neighbouring filter channels 502 are separated by separating walls 510. In alternative embodiments, more than one channel may be connected to a same sample inlet and different channels may have different fluid inlets and outlets.

Device 500 and its variations may be advantageous to use. It is possible to inject into each channel 502 a different sample or probe (signal producing members). By injecting different probes in different channels, multiple analytes in one sample can be detected simultaneously. By injecting different samples in different channels, simultaneous detection of an analyte in the different samples can be achieved within a short period of time, such as in a few minutes. In alternative embodiments where different channels have different fluid inlets and outlets, it is possible to detect different analytes simultaneously by flowing different carrying fluids through different fluid inlet/outlet pairs.

Other types of filters, such as post-type or comb-type of filters may also be used for detecting an analyte. For example, the types of filters disclosed in Wilding may be used.

To prevent large particles in the sample solution from clogging the fluid conduit(s) or channels, one or more preliminary coarse screens for filtering out the large particles may also be placed an inlet port such as port 216 or sample inlet 504.

Further, a filter can extend across the entire or substantially entire width of a wide fluid path to reduce flow resistance inside the fluid path, so that it is possible to maintain high flow rate and process large volume of sample solution.

### EXAMPLE

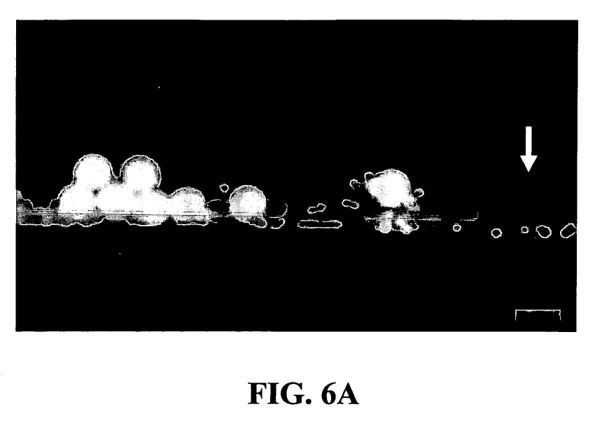

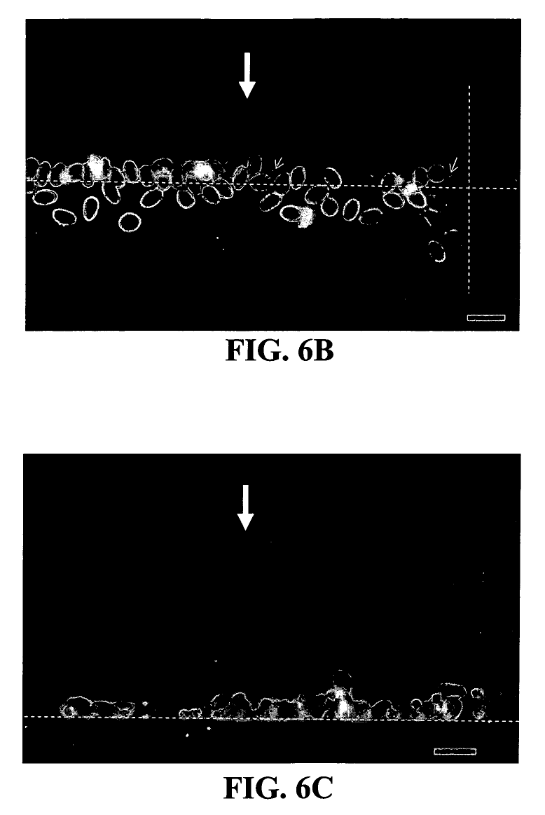

FIG. 6A is an image taken during an example procedure for detecting florescent beads. The device used had three parallel weir-type filters as illustrated in FIGS. 2A and 2B. The weir gaps were about 3-4 μm deep. The beads had diameters of 1, 4, 10 and 15 μm. The beads were injected into the conduits and flushed with water at a flow rate of 20 μl/min. An epifluorescence microscope was used to monitor the locations of the beads. The microscope had a cooled charge-coupled device (CCD) camera, a 100W HBO™ bulb, and appropriate filter sets. As shown, the larger beads were all trapped before the weirs. It was observed that the 1 μm beads passed through the weirs. A similar test with a device of weirs about 1 to 2 μm deep showed similar result: only 1 μm beads passed through the filer and the larger beads were trapped.

FIGS. 6B and 6C are images taken in procedures carried out for detecting microbial cells Cryptosporidium spp. and Giardia spp., both being protozoan cells, using the same devices as described in the previous paragraph.

Cryptosporidium spp. cells were roughly round-shaped having diameters of about 2 to 6 μm. Giardia spp. cells were roughly oval-shaped, about 8-13 μm in length and about 7 to 10 μm in width. Both types of protozoan cells were freshly fixed in 5% formalin at a concentration of approximately one million cell/ml.

The signal producing members used were immunofluorescent monoclonal antibodies respectively specific to the two types of protozoan cells. The antibodies were obtained from Waterborne Inc. in an A 100DF, AquaGlo™ Dual Fluorochrome Kit.

Initially, the chambers and conduits of the devices were flushed with phosphate-buffered saline (PBS) for 2 minutes at a flow rate about 20 μl/min. Next, about 5 μl of the sample solution, which contained about 5,000 to 10,000 targeted cells, was delivered into the chambers of the device using a micro-syringe. A labelling solution containing the fluorescent-labelled antibodies was then pumped through the device at a constant rate (about 20 μl/min ) using a syringe pump to flush and push the targeted cells toward the weirs. As the labelling solution was flown through the device and the filtering component, the fluorescent signals produced by the labelled probes were detected in real-time, with the epifluorescence microscope.

As shown in FIG. 6B, with weir gaps 3 to 4 μm deep, few target cells sized 3 to 5 μm were trapped but most cells sized 5 to 10 μm were trapped in front of the weirs. As shown in FIG. 6C, whit weir gaps 1 to 2 μm deep, almost all of the microbial cells with a size greater than 3 μm were effectively trapped in front of the weirs. Without being limited to a particular theory, it is believed that microbial cells could deform so that smaller cells could pass through the weirs while large cells could not even after deformation.

Therefore, it can be appreciated that to detect a deformable analyte in accordance with an embodiment of the invention, the filter mesh size may need to be sufficiently smaller than the analyte size to trap the analyte upstream of the filter. In this regard, the fluid flow rate may also need to be limited. Tests showed that high flow rates could cause pressure build-up in the fluid conduits and thus cause extensive deformation of the deformable analyte, even forcing the deformed analyte into or through the weir gaps. However, simulation studies showed that adjusting the pillar orientation can significantly reduce the pressure build up inside the channels.

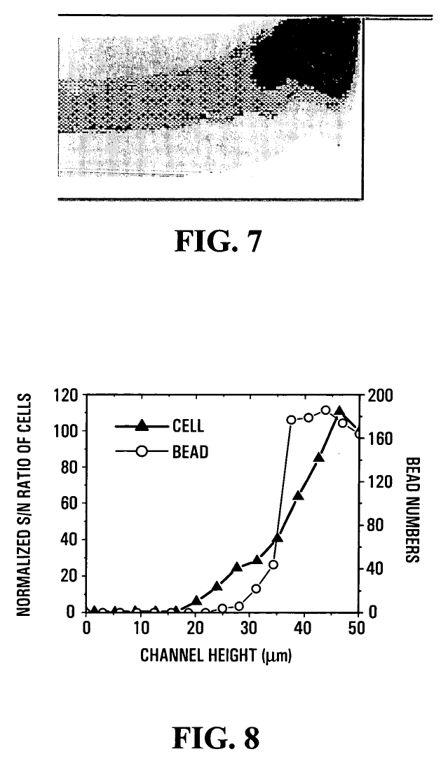

As can be appreciated, it may be desirable to limit the dead volume or dead zone in the conduit. FIG. 7 is a simulated flow rate profile showing the dead zone in filter 200, with a weir depth of 1 to 2 μm and a flow rate of 20 μl/min. A dead zone refers to a region in the conduit where there is no fluid flow or the flow rate is close to zero. In FIG. 7, the dark area has high flow rate; the light area has low flow rate; and the while area is dead zone. Test results showed that, within a certain range, increasing flow rate had little effect on the dead zone in the conduit. As can be understood, changing the size and the shape of the conduit or its various sections can significantly affect the size of the dead zone. For example, reducing the depth of the deep section 206 in filter 200 can significantly reduce the dead zone. Dead zone can also be small in a pillar-type of filtering configuration. Further, a dead zone in a device such as device 400 can be advantageous because it forces the analyte to stay in a specific area.

FIG. 8 shows the signal intensity profiles as measured in the above tests. The fluorescent signal profiles were taken along the conduit depth from bottom to top just upstream of the weir, using a laser scanning confocal microscope. As can be seen, the signal strength from the trapped cells increased rapidly above about 35 μm. No or little signal was detected within the dead zone, which is below about 20 μm. Thus, most detected cells were located close to the weir gap. Similarly, the detected number of fluorescently labelled beads dropped quickly from 177 at 37 μm to 44 at 34 μm. Without being limited to a particular theory, the reduced signal from the dead zone is likely due to the decreased number of cells in the dead zone (cells are likely pushed against the weir gap), or the decreased number of labelling antibodies in the dead zone, or both.

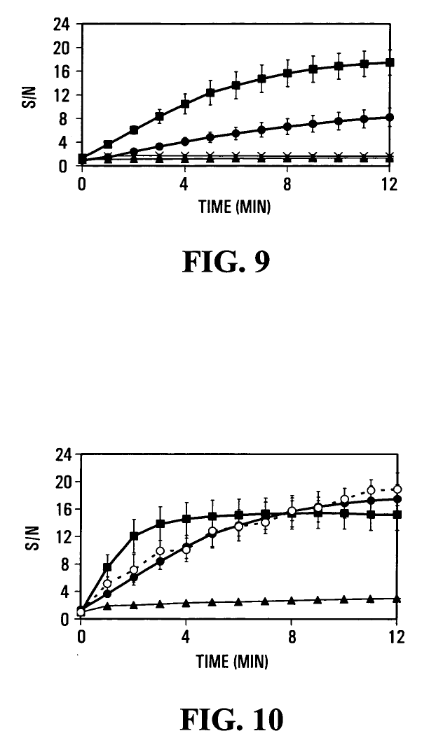

FIG. 9 shows the time dependence of signal to noise ratio (S/N) measured under different fluid flow rates and a fixed labelling solution concentration. Values of S/N were measured every minute for 12 minutes. The flow rates were respectively 2 μl/min (crosses), 10 μl/min (circles), and 20 μl/min, (squares). The triangles represent signals detected from cells deposited on a glass slide, which are included for comparison purposes. As can be seen, the signal strength depends on the flow rate and the total time in which the analyte is exposed to the flow. The higher the flow rate, the higher the detected signal strength. The longer the exposure, the higher the signal strength. When the flow rate is very low, there is little change in signal strength over time. Moreover, when the flow rate is sufficiently high, the signal strength gradually levels off and reaches a plateau after the flow has been maintained for a long period of time, when the surface of the target cells is saturated with the antibodies.

As can be understood, for this particular device, a flow rate of 20 μl/min provides good performance: it is high enough for pushing the target cells against the weirs and for reaching the saturation signal strength within a short period of time, yet low enough to not deform the cells and pushes them through the weirs.

FIG. 10 shows the time dependence of signal to noise ratio (S/N) measured under a constant flow rate (20 μl/min) but different labelling solution concentrations, namely 10× diluted (solid square), 100× diluted (solid circle), and 500× diluted (solid triangle). The number before “×” refers to the volume ratio between the diluting solution and the original solution, or the ratio between the original concentration and the diluted concentration. Again, for comparison, signals detected on glass slide with 1× labelling solution concentration was also shown (open circle). As can be seen, 10× diluted labelling solution produced the strongest signal (excluding the signal from glass slide) within the first 7 minutes: its S/N ratio rapidly increased to 7.51 after 1 minute, and levelled off at a plateau around 15 after 5 minutes. However, the 100× diluted labelling solution produced a stronger signal after 8 minutes, reaching approximately 17 at the 12 minutes mark. The above result is likely due to the relatively high fluorescence background in the 10× diluted labelling solution. The 500× diluted labelling solution produced a low strength signal even after 12 minutes. The signal strength or labelling efficiency of the microfluidic device was further compared with the signal strength produced by labelled cells on a conventional glass slide. As can be seen, a 1× labelling solution on a glass slide produced a signal of similar strength to that of the 100× diluted labelling solution at a flow rate of 20 μl/min in the microfluidic device. In other words, using the exemplary method and microfluidic device described above, detection of microbial cells can be performed using less concentrated labelling solutions (or with less consumption of labelling solutions), as compared to conventional glass slide analysis.

Other features, benefits and advantages of the embodiments described herein not expressly mentioned above can be understood from this description and the drawings by those skilled in the art.

Although only exemplary embodiments of this invention have been described above, those skilled in the art will readily appreciate that many modifications are possible therein without materially departing from the novel teachings and advantages of this invention. The invention, rather, is intended to encompass all such modification within its scope, as defined by the claims.

What is claimed is:

1. A method of detecting an analyte, comprising:
flowing a fluid through a filter, said fluid carrying signal producing members smaller in size than said analyte and having affinity to specifically attach to said analyte, said filter adapted for trapping said analyte while allowing passage of unattached ones of said signal producing members; and
sensing a signal produced by one or more of said signal producing members upstream of said filter so as to detect said analyte trapped by said filter.

2. The method of claim 1, further comprising passing a fluid sample through said filter so as to detect said analyte contained in said fluid sample.

3. The method of claim 2, wherein said flowing comprises flowing said fluid for a period of time after said passing a fluid sample through said filter to allow accumulation of attached ones of said signal producing members so as to increase the strength of said signal.

4. The method of claim 2 further comprising screening said fluid sample before passing said fluid sample through said filter so as to screen out objects in said fluid sample that are larger than said analyte.

5. The method of claim 1, wherein said analyte comprises one or more microbial cells.

6. The method of claim 1, wherein said signal is a radioactive, fluorescent, chemiluminescent, colorimetric, electric, magnetic, or electromagnetic signal.

7. The method of claim 1, wherein said analyte comprises a target molecule on a surface of said analyte and each one of said signal producing members comprises a labeled capture molecule having an affinity to specifically capture said target molecule.

8. The method of claim 7, wherein said labeled capture molecule has a label which is radioactive, fluorescent, colorimetric, electric, or magnetic.

9. The method of claim 7, wherein said capture molecule has an affinity to be specifically conjugated, linked, or bonded to said target molecule.

10. The method of claim 9, wherein said capture molecule can bind selectively to said target molecule, either covalently or non-covalently.

11. The method of claim 10, wherein said capture molecule and said target molecule are paired antigen and antibody, paired ligand and receptor, paired biotin and avidin, or paired substrate and enzyme.

12. The method of claim 1, wherein said signal producing members comprise quantum dots or gold nanoparticles.

13. The method of claim 1, wherein said detecting comprises determining presence or amount of said analyte.

14. The method of claim 1, wherein said flowing comprises flowing said fluid at a substantially constant flow rate.

15. The method of claim 1, wherein said filter is provided on a microfluidic device.

16. The method of claim 15, wherein said filter comprises a fluid conduit having contiguous first and second sections, said first section having a cross-section sufficiently large to allow movement of said analyte therein, said second section having a cross-section sufficiently large to allow passage of said signal producing members but sufficiently small to prevent entrance of said analyte.

17. The method of claim 16, wherein said filter is a weir-type filter or a pillar-type filter.

18. A device for detecting an analyte, comprising:
a body having walls defining a fluid path;
a filter for trapping said analyte in said fluid path but allowing passage of signal producing members smaller in size than said analyte and having affinity to specifically attach to said analyte;
said analyte trapped in said path by said filter; and
at least one of said walls allowing transmission of a signal produced by said signal producing members attached to said analyte such that said analyte can be detected by sensing said signal.

19. The device of claim 18, wherein said body comprises a base plate and a transparent cover plate.

20. The device of claim 18, wherein said analyte comprises one or more microbial cells.

21. The device of claim 18, wherein said signal is a radioactive, fluorescent, chemiluminescent, colorimetric, electric, magnetic, or electromagnetic signal.

22. The device of claim 18, wherein said filter comprises a fluid conduit having contiguous first and second sections, said first section having a cross-section sufficiently large to allow movement of said analyte therein, said second section having a cross-section sufficiently large to allow passage of said signal producing members but sufficiently small to prevent entrance of said analyte.

23. The device of claim 22, wherein said filter is a weir-type filter or a pillar-type filter.

24. The device of claim 22, wherein said analyte is selected from the group of Cryptosporidium spp. and Giardia spp.

25. The device of claim 18 further comprising one or more coarse screens disposed upstream of said filter for screening out objects larger than said analyte.

26. The device of claim 18 wherein said filter is one of a plurality of filters.

27. A device for detecting an analyte, comprising:
a wall having a first portion and a second portion, said first and second portions defining a fluid path, said path having a substantially closed, downstream end and an open, upstream end, said path narrowing from said upstream end towards said downstream end, each of said first and second portions having a plurality of openings disposed along said path to allow a fluid to pass through said wall, said openings being sufficiently small for preventing passage of an analyte carried by said fluid, wherein said fluid tends to force said analyte in said path towards said downstream end to leave at least some of said openings unblocked by said analyte;
an inlet in fluid communication with said path for feeding said fluid and said analyte into said upstream end of said path; and
an outlet in fluid communication with said openings for allowing said fluid to exit said path.

28. The device of claim 27, wherein said wall is generally V-shaped or generally U-shaped.

29. The device of claim 27, further comprising said analyte trapped in said path by said wall.

30. The device of claim 27, further comprising a cover covering said path, said cover allowing transmission of a signal produced by signal producing members attached to said analyte such that said analyte can be detected by sensing said signal

31. A device for detecting an analyte, comprising:
a body having walls defining a fluid path;
a filter for trapping said analyte in said fluid path but allowing passage of signal producing members smaller in size than said analyte and having affinity to specifically attach to said analyte;
a screen disposed upstream of said filter in said fluid path for blocking objects larger than said analyte; and
at least one of said walls allowing transmission of a signal produced by said signal producing members attached to said analyte such that said analyte can be detected by sensing said signal.

32. The device of claim 31, wherein said screen is a first screen, and said device comprising a second screen disposed upstream of said first screen for blocking objects larger than said analyte, said second screen having a mesh size larger than the mesh size of said first screen.
